(19) United States
(12) Patent Application Publication
(10) Pub. No.: US 2020/0404746 A1
(43) Pub. Date: Dec. 24, 2020

(54) MEDICAL CONTAINER

(71) Applicant: TERUMO KABUSHIKI KAISHA, Tokyo (JP)

(72) Inventor: YUSUKE NOZAKI, Kanagawa (JP)

(21) Appl. No.: 17/014,764

(22) Filed: Sep. 8, 2020

Related U.S. Application Data
(63) Continuation of application No. PCT/JP2019/009321, filed on Mar. 8, 2019.

(30) Foreign Application Priority Data
Mar. 13, 2018 (JP) 2018-045054

(51) Int. Cl. H05B 1/02; A61J 1/16; A61J 1/14; A61J 1/10; H05B 3/03; H05B 3/48

(52) U.S. Cl. CPC H05B 1/025; A61J 1/16; A61J 1/1475; A61J 1/10; H05B 2203/007; H05B 3/48; A61J 2200/42; A61J 2200/72; H05B 3/03

(57) ABSTRACT

A medical container is provided comprising a container body that contains a bio-derived frozen product, and a heating unit that heats the bio-derived frozen product contained in the container body. The medical container efficiently heats the bio-derived frozen product. The medical container rapidly melts the bio-derived frozen product contained in the medical container. Additionally, the medical container is hygienic since hot water does not directly contact an outer surface of the medical container.

### CROSS REFERENCE TO RELATED APPLICATIONS

The present application is a continuation of and claims benefit to PCT Application No. PCT/JP2019/009321 filed on Mar. 8, 2019, entitled “MEDICAL CONTAINER” which claims priority to Japanese Patent Application No. 2018-045054 filed on Mar. 13, 2018. The entire disclosures of the applications listed above are hereby incorporated herein by reference, in their entirety, for all that they teach and for all purposes.

### FIELD

The present disclosure relates to a medical container that contains a bio-derived frozen product.

### BACKGROUND

Conventionally, a method of immersing a container in a constant temperature water tank is generally used to melt (e.g., thaw, unfreeze, etc.) a bio-derived frozen product such as a frozen cell contained in the container such as a bag. However, there is a concern regarding a hygienic problem in such a melting method using hot water. European Patent Application No. 0318924 proposes a device that sandwiches a container from above and below with two heating bags and melts a bio-derived frozen product in the container.

### SUMMARY

In the related art, however, the heat transfer from the heating bag to the medical container is not efficiently performed and it takes a long time to melt the bio-derived frozen product with conventional devices.

The present disclosure has been made in consideration of such problems, and an object of the present disclosure is to provide a medical container capable of hygienically and rapidly melting a contained bio-derived frozen product.

In some embodiments, a medical container is provided for containing a bio-derived frozen product including: a container body that contains the bio-derived frozen product; and a heating unit that is provided in the container body and heats the bio-derived frozen product contained in the container body.

According to embodiments of the melting device, the container body is provided with the heating unit that heats the bio-derived frozen product, and thus, the bio-derived frozen product can be efficiently heated. Therefore, it is possible to rapidly melt the bio-derived frozen product contained in the medical container. In addition, it is hygienic since hot water does not directly contact an outer surface of the medical container.

In some embodiments, the heating unit may be arranged inside, or within, the container body.

With this configuration, the heating unit directly contacts the bio-derived frozen product, and thus, the bio-derived frozen product can be heated more efficiently and can be melted more rapidly.

In some embodiments, the heating unit may be arranged in the bio-derived frozen product.

With this arrangement, the contact area between the bio-derived frozen product and the heating unit increases, and thus, the bio-derived frozen product can be heated more efficiently, and can be melted more rapidly than an arrangement where the heating unit is separate from the container and/or the bio-derived frozen product.

The heating unit may be a heat transfer member that transfers heat from a heat generating section provided outside the container body into the container body.

As a result, it is possible to efficiently heat the bio-derived frozen product from the inside of the container body with a simple configuration.

The heating unit may be a heat generating body that generates heat by Joule heat (e.g., electroconductive, Ohmic, resistive, and/or resistance heating, etc.). For instance, the heat may be generated by the passage of electrical current through a material (e.g., a conductor, etc.) to generate or otherwise produce heat.

With this arrangement, the bio-derived frozen product can be effectively heated using the heating unit that generates heat for itself.

The heating unit may include a plurality of linear heating bodies.

With this arrangement, the bio-derived frozen product can be efficiently heated over a wide range (e.g., area, etc.), and thus, the bio-derived frozen product can be more rapidly melted.

A temperature detection probe (e.g., a thermistor, thermocouple, temperature sensor, etc.) may be provided inside the container body.

With this arrangement, the temperature during heating can be monitored by the temperature detection probe to, among other things, prevent overheating and/or otherwise control a heating of the bio-derived frozen product.

In some embodiments, the heating unit may be provided on the outer surface of the container body.

As a result, it is possible to efficiently heat the bio-derived frozen product with a simple configuration.

Embodiments of the medical container of the present disclosure allow the contained bio-derived frozen product to be hygienically and rapidly melted, or thawed.

### BRIEF DESCRIPTION OF THE DRAWINGS

FIG. 1 is a perspective view of a medical container and a melting device according to a first embodiment of the present disclosure;

FIG. 2 is a plan view of the medical container shown in FIG. 1;

FIG. 3 is a schematic cross-sectional view illustrating a state where the medical container is contained in the melting device;

FIG. 4 is a perspective view of a medical container and a melting device according to a second embodiment of the present disclosure; and

FIG. 5 is a plan view of a medical container according to a third embodiment of the present disclosure.

### DETAILED DESCRIPTION

Hereinafter, preferred embodiments of a medical container according to the present disclosure will be described with reference to the accompanying drawings.

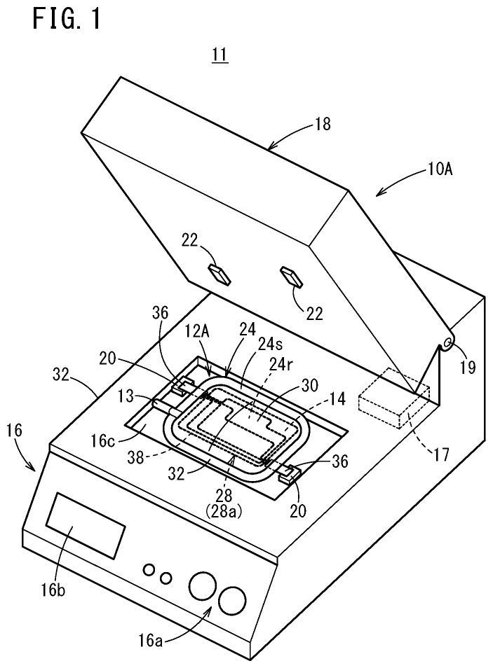

A melting device 10A illustrated in FIG. 1 is used to melt a bio-derived frozen product 14 contained in a medical container 12A. A melting system 11 may comprise the melting device 10A and the medical container 12A.

The melting device 10A includes a main body 16 and a lid 18 movably (e.g., pivotally, etc.) connected to the main body 16.

As illustrated in FIG. 1, the main body 16 is provided with: an operation section 16a including an operation button configured to operate operation start, operation stop, and the like, and setting buttons for various settings; and a display 16b that displays various types of information (e.g., set time, remaining time, set temperature, probe temperature, and the like).

The main body 16 has two heat generating sections 20 as contact sections which come into contact with the medical container 12A to heat the bio-derived frozen product 14 in the medical container 12A. Examples of the heat generating section 20 include a mechanism that generates heat by Joule heat (e.g., electroconductive, Ohmic, resistive, and/or resistance heating, etc.) accompanying energization and a heat radiating surface of, for instance, a Peltier element. In some embodiments, the heat may be generated by the passage of electrical current through a material (e.g., a conductor, etc.) to generate or otherwise produce heat. The heat generating section 20 is controlled by a control unit 17 provided in the main body 16. An arrangement groove 16c for arrangement of the medical container 12A is provided on an upper surface of the main body 16. The heat generating sections 20 are provided at positions spaced apart from each other on a bottom of the arrangement groove 16c, or cavity.

The lid 18 is rotatably connected to the main body 16 via a hinge portion 19 and can be open and closed with respect to the main body 16. For instance, the lid 18 may be moved (e.g., pivoted about the hinge portion, or hinge) to translate between an open state and a closed state. The lid 18 is provided with two pressing portions 22 protruding downward. The two pressing portions 22 are provided at positions spaced apart from each other on a lower surface of the lid 18. A function of the pressing portion 22 will be described later. In some embodiments, the pressing portions 22 may be made from an elastomeric material (e.g., silicone, rubber, urethane, etc.). In one embodiment, the pressing portions 22 may be made from a metal, a plastic, a composite material, and/or combinations thereof. When the lid 18 is in the closed state, the pressing portions 22 may contact the heat generating sections 20 and maintain at least a portion of the medical container 12A in position within the groove 16c. Additionally or alternatively, a lock mechanism (e.g., a hook, a latch, etc.) may be provided to maintain the lid 18 in a closed state when closed.

The medical container 12A may include a container body 24 that contains the bio-derived frozen product 14 and a heating unit 28 that is provided in the container body 24 and that heats the bio-derived frozen product 14 contained in the container body 24.

The container body 24 is, for example, a soft bag made of a resin film and is flexible or easily deformed. The container body 24 may have a flat shape as a whole and may be formed in a quadrangular shape when viewed in a plan view. The container body 24 may be formed in a shape other than the quadrangular shape when viewed in the plan view, for example, the shape of the container body 24 may comprise a circular shape, an elliptical shape, combinations thereof, and/or the like. The container body 24 may have a shape other than the flat shape. In some embodiments, the container body 24 may be made of a hard material.

The bio-derived frozen product 14 contained in the container body 24 is obtained by freezing a liquid containing a bio-derived substance (e.g., a bio-derived liquid product). Examples of the bio-derived liquid product include a cell suspension, blood, plasma, and the like. Examples of the cell suspension include hematopoietic stem cells (umbilical cord blood, bone marrow fluid, a peripheral blood stem cell, and the like) used for stem cell transplantation. Cells in the cell suspension are not limited thereto, and are cells such as adherents cells such as myoblasts, cardiomyocytes, fibroblasts, synovial cells, epithelial cells, endothelial cells, hepatocytes, pancreatic cells, renal cells, adrenal cells, periodontal ligament cells, gingival cells, periosteal cells, skin cells, and chondrocytes, blood cells and blood components such as whole blood, red blood cells, white blood cells, lymphocytes (T lymphocytes, B lymphocytes), dendritic cells, plasma, platelets, and platelet-rich plasma, Bone Marrow Derived Mononuclear Cells, hematopoietic stem cells, ES cells, pluripotent stem cells, iPS cell-derived cells (e.g., iPS cell-derived cardiomyocytes, etc.), mesenchymal stem cells (e.g., those derived from bone marrow, adipose tissue, peripheral blood, skin, hair root, muscle tissue, endometrium, placenta, cord blood, and the like), and/or gametes (e.g., sperm cells and/or egg cells, etc.). These cells may be cells into which a gene used for gene therapy or the like has been introduced.

The container body 24 may be made by joining outer circumferential portions of two sheet materials 24s to each other. In one embodiment, the outer circumferential portions of the two sheet materials may be joined by heat sealing, ultrasonic welding, compression, adhesively joining, and/or otherwise attaching the circumferential portion of a first sheet material to the circumferential portion of a second sheet material forming the container body 24. Specifically, the container body 24 has a bag-shaped storage chamber forming portion 30 that forms a storage chamber 24r therein, and a plate-shaped circumferential edge portion 32 (e.g., a flat flanged region, etc.) that surrounds an outer circumference of the storage chamber forming portion 30. The circumferential edge portion 32 is provided with a port 13 configured to extract a bio-derived liquid product from the medical container 12A (e.g., in a melted or thawed state, etc.).

The heating unit 28 may be arranged inside the container body 24. In some embodiments, the heating unit 28 may be arranged in the bio-derived frozen product 14. The heating unit 28 may include a heat transfer member 28a that transfers heat from the heat generating section 20 provided in the melting device 10A outside the container body 24 into the container body 24. In some embodiments, the heating unit 28 may comprise a material (e.g., a conductive or resistive element) through which an electrical current is passed. In this example, the heat generating section 20 may correspond to different or opposing electrical terminals. Continuing this example, when the electrical current is passed from one of the electrical terminals to the other of the electrical terminals through the heating unit 28, resistive heat may be generated and pass from the heat transfer member 28a into the container body 24.

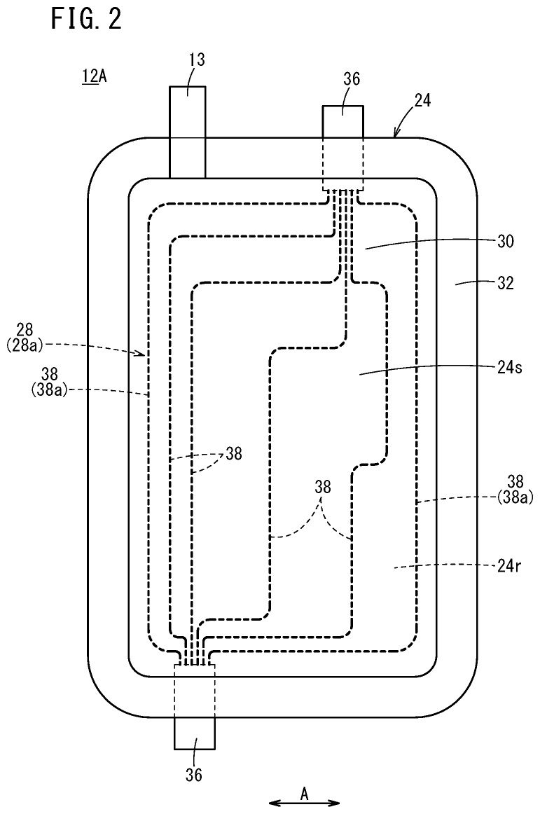

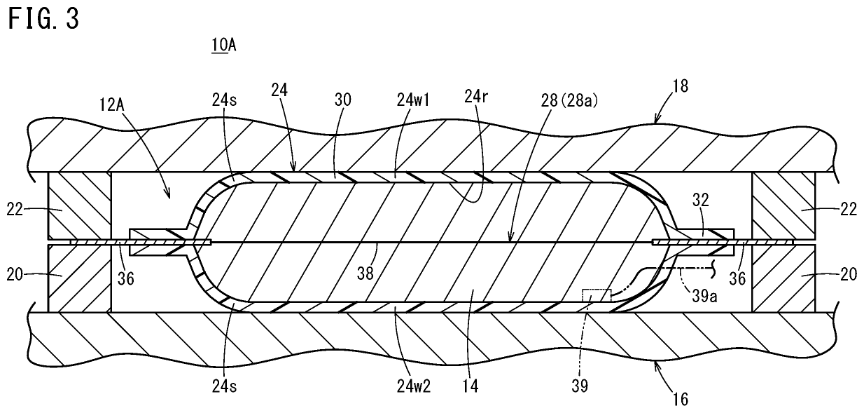

As illustrated in FIGS. 2 and 3, the heat transfer member 28a includes two heat receiving portions 36 exposed to the outside of the container body 24, and linear heat transfer bodies 38 as a plurality of linear heating bodies connected to the two heat receiving portions 36.

The two heat receiving portions 36 are arranged on the circumferential edge portion 32 of the container body 24 and are supported by the circumferential edge portion 32. Each of the heat receiving portions 36 is arranged between the two sheet materials 24s constituting the container body 24 at the circumferential edge portion 32. Each of the heat receiving portions 36 is, for example, a metal plate. One end of each of the heat receiving portions 36 reaches the inside (e.g., the storage chamber 24r) of the container body 24.

As illustrated in FIG. 2, the plurality of linear heat transfer bodies 38 may be arranged in parallel in a width direction (e.g., the direction of arrow A) of the container body 24. The heat transfer member 28a may have three or more linear heat transfer bodies 38 as in the first embodiment. Among the three or more linear heat transfer bodies 38 arranged in parallel, linear heat transfer bodies 38a located on both sides are arranged along the circumferential edge portion 32 in the vicinity of the circumferential edge portion 32 of the container body 24. One end of each of the plurality of linear heat transfer bodies 38 is connected to one heat receiving portion 36. The other ends of the plurality of linear heat transfer bodies 38 are connected to the other heat receiving portion 36.

As illustrated in FIG. 3, the plurality of linear heat transfer bodies 38 are arranged inside the container body 24 in a state of being embedded in the bio-derived frozen product 14. That is, the bio-derived frozen product 14 covers the plurality of linear heat transfer bodies 38. Therefore, the bio-derived frozen product 14 exists between a wall portion 24w1 that constitutes one surface of the container body 24 having the flat shape and the plurality of linear heat transfer bodies 38. In addition, the bio-derived frozen product 14 exists between a wall portion 24w2 forming the other surface of the container body 24 having the flat shape and the plurality of linear heat transfer bodies 38.

The heat generating section 20 provided in the main body 16 is arranged so as to abut on the heat receiving portion 36 when the medical container 12A is placed on the main body 16. Each of the pressing portions 22 provided on the lid 18 is arranged so as to hold each of the two heat receiving portions 36 against the heat generating section 20 when the lid 18 is closed.

Next, operations of the melting device 10A and the medical container 12A configured as described above will be described.

When the bio-derived frozen product 14 contained in the medical container 12A is ready to be melted using the melting device 10A, the lid 18 may be opened, and the medical container 12A containing the bio-derived frozen product 14 can be placed on the main body 16 in a predetermined direction (arranged in the arrangement groove 16c, or cavity) as illustrated in FIG. 1.

Then, when the lid 18 is closed (e.g., moved from the open state to the closed state, etc.), the medical container 12A is housed in the melting device 10A as illustrated in FIG. 3. As the lid 18 is closed, each of the two heat receiving portions 36 of the heat transfer member 28a provided in the medical container 12A is sandwiched between each of the two heat generating sections 20 provided on the main body 16 and each of the two pressing portions 22 provided on the lid 18. As a result, the two heat receiving portions 36 firmly abut on the heat generating sections 20.

When a start button of the operation section 16a (FIG. 1) provided in the main body 16 is operated, the melting device 10A starts operating. Specifically, the heat generating section 20 is heated to a predetermined temperature (e.g., 30° C. to 40° C.) As the heat generating section 20 is heated, the heat of the heat generating section 20 is transferred to the bio-derived frozen product 14 inside the medical container 12A via the heat transfer member 28a. Specifically, the heat of the heat generating section 20 is transferred to the plurality of linear heat transfer bodies 38 via the two heat receiving portions 36. Since the plurality of linear heat transfer bodies 38 are arranged in parallel in the width direction of the medical container 12A (FIG. 2), the bio-derived frozen product 14 is heated over a wide range (e.g., area, etc.) by the plurality of linear heat transfer bodies 38.

In this manner, the bio-derived frozen product 14 inside the medical container 12A is heated by the heat transfer member 28a, and the entire bio-derived frozen product 14 is melted as the heating is maintained for a certain period of time.

The medical container 12A according to the present embodiment has the following effects.

According to the medical container 12A, the container body 24 is provided with the heating unit 28 that heats the bio-derived frozen product 14, and thus, the bio-derived frozen product 14 can be efficiently heated. Therefore, it is possible to rapidly melt the bio-derived frozen product 14 contained in the medical container 12A. In addition, the melting process provided by the medical container 12A described herein is hygienic since, among other things, hot water does not directly contact an outer surface of the medical container 12A.

The heating unit 28 is arranged inside the container body 24. With this arrangement, the heating unit 28 directly contacts the bio-derived frozen product 14, and thus, the bio-derived frozen product 14 can be heated more efficiently and can be melted more rapidly than conventional devices and systems.

The heating unit 28 is arranged in the bio-derived frozen product 14. With this arrangement, the contact area between the bio-derived frozen product 14 and the heating unit 28 increases, and thus, the bio-derived frozen product 14 can be heated more efficiently, and can be melted more rapidly than conventional devices and systems.

The heating unit 28 includes a heat transfer member 28a that transfers heat of the heat generating section 20 provided outside the container body 24 into the container body 24. As a result, it is possible to efficiently heat the bio-derived frozen product 14 from the inside of the container body 24 with a simple configuration.

The heating unit 28 has the plurality of linear heating bodies. With this configuration, the bio-derived frozen product 14 can be efficiently heated over a wide range, and thus, the bio-derived frozen product 14 can be more rapidly melted than conventional devices and systems.

As illustrated in FIG. 3, the medical container 12A may have a temperature detection probe 39. In some embodiments, the temperature probe 39 may correspond to a thermistor, thermocouple, thermometer, or other temperature sensor. The temperature detection probe 39 may be arranged, for example, inside the container body 24 and may come into direct contact with the bio-derived frozen product 14. The temperature detection probe 39 is electrically connected to a terminal (not illustrated) via a lead wire 39a penetrating through the wall portion 24w2 of the container body 24, for example. This terminal is arranged at the circumferential edge portion 32, for example. On the other hand, the main body 16 is provided with another terminal (not illustrated). When the medical container 12A is arranged at a predetermined position of the main body 16, the terminal on the side of the medical container 12A and the terminal on the side of the main body 16 come into contact with each other to be electrically connected. During the melting operation, the melting device 10A monitors the temperature inside the container body 24 using the temperature detection probe 39. When the temperature inside the container body 24 reaches a predetermined temperature (e.g., 2° C. to 6° C.), the control unit 17 (FIG. 1) stops energizing the heat generating section 20 (e.g., controlling the output of the heat generating section 20, etc.). This prevents overheating of the bio-derived liquid product.

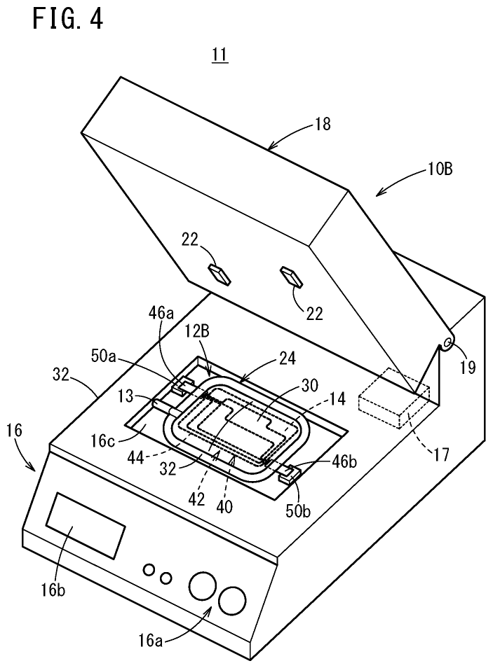

A medical container 12B according to a second embodiment illustrated in FIG. 4 is different from the medical container 12A according to the first embodiment in terms of a configuration of a heating unit 40. Specifically, the heating unit 40 of this medical container 12B has a heat generating body 42 that generates heat by Joule heat accompanying energization. The heat generating body 42 includes heating wires 44 as a plurality of linear heating bodies. The plurality of heating wires 44 are arranged inside the container body 24 in the same manner as the plurality of linear heat transfer bodies 38 illustrated in FIG. 2.

The heating unit 40 further has a first energization terminal 46a and a second energization terminal 46b connected to the plurality of heating wires 44. The first energization terminal 46a and the second energization terminal 46b are arranged in the circumferential edge portion 32 of the container body 24. The first energization terminal 46a and the second energization terminal 46b are respectively arranged on sides of the circumferential edge portion 32 on the opposite sides of the container body 24. Each of the energization terminals 46a and 46b is formed in a plate shape.

The melting device 10B has a first electrode 50a and a second electrode 50b as contact portions that come into contact with the medical container 12B in order to heat the bio-derived frozen product 14 in the medical container 12B. The first electrode 50a and the second electrode 50b are provided in the main body 16. The first electrode 50a is, for example, a positive electrode, and the second electrode 50b is, for example, a negative electrode.

The first electrode 50a and the second electrode 50b are arranged so as to abut on the first energization terminal 46a and the second energization terminal 46b when the medical container 12B is placed on the main body 16. The pressing portions 22 provided on the lid 18 are arranged so as to respectively sandwich the first energization terminal 46a and the second energization terminal 46b of the container body 24 between the first electrode 50a and the second electrode 50b when the lid 18 is closed.

When the lid 18 is open to place the medical container 12B containing the bio-derived frozen product 14 on the main body 16 in a predetermined direction, and then, the lid 18 is closed, the medical container 12B is housed inside the melting device 10B. Then, when a start button of the operation section 16a provided in the main body 16 is operated, the melting device 10B starts operating.

Specifically, the heat generating body 42 including the plurality of heating wires 44 is energized through the first electrode 50a and the second electrode 50b. The heat generating body 42 generates heat by Joule heat accompanying the energization. As a result, the heat generating body 42 is heated to a predetermined temperature (e.g., 30° C. to 40° C.). Since the plurality of heating wires 44 forming the heat generating body 42 are arranged in parallel in the width direction of the medical container 12B, the bio-derived frozen product 14 is heated in a balanced manner by the plurality of heating wires 44.

Even with the medical container 12B according to the second embodiment, it is possible to hygienically and rapidly melt the stored bio-derived frozen product 14, which is similar to the medical container 12A according to the first embodiment.

In addition, the heating unit 40 is the heat generating body 42 that generates heat by Joule heat according to this medical container 12B. With this configuration, the bio-derived frozen product 14 can be effectively heated using the heating unit 40 that generates heat for itself.

Additionally or alternatively, the same or similar functions and effects as those of the first embodiment can be obtained in the second embodiment for common parts with the first embodiment, or vice versa.

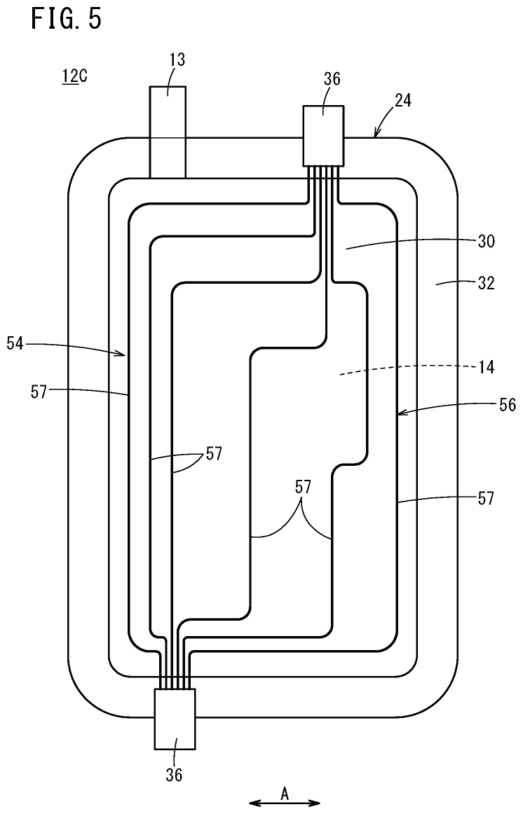

A heating unit 54 of a medical container 12C according to a third embodiment illustrated in FIG. 5 has a heat transfer member 56 arranged on an outer surface of the container body 24. The heat transfer member 56 has a plurality of linear heat transfer bodies 57. The plurality of linear heat transfer bodies 57 are configured in the same manner as the plurality of linear heat transfer bodies 38 illustrated in FIG. 2, except that arrangement positions are set on the outer surface of the container body 24 (specifically, the outer surface of the storage chamber forming portion 30).

Additionally or alternatively, the heat transfer member 56 may be arranged on both surfaces in the thickness direction of the container body 24 having a flat shape. Instead of the heat transfer member 56 having the plurality of linear heat transfer bodies 57, the heat generating body 42 having the plurality of heating wires 44 illustrated in FIG. 4 may be arranged on the outer surface of the container body 24.

According to the medical container 12C of the third embodiment, it is possible to efficiently heat the bio-derived frozen product 14 and to rapidly melt the bio-derived frozen product 14 with a simpler configuration than conventional devices and systems.

Additionally or alternatively, a configuration may be provided in which the heating unit 28 of the first embodiment (FIG. 1) or the heating unit 40 of the second embodiment (FIG. 4) may be combined with the heating unit 54 (FIG. 5) according to the third embodiment to heat the bio-derived frozen product 14 from both the inside and outside of the container body 24, or vice versa.

The present disclosure is not limited to the above-described embodiment, and various modifications can be made within a scope not departing from a gist of the present disclosure.

For example, in one aspect of the present disclosure, a heating unit arranged in the container body 24 may be a channel member (e.g., a tube, series of tubes, etc.) that allows a heating liquid (e.g., hot water, heated fluid, etc.) to flow therethrough. In this case, the channel member may be arranged inside the container body 24 or provided on the outer surface of the container body 24. In some embodiments, the channel member may be provided on both the inside and the outside of the container body 24.

What is claimed is:

1. A medical container configured to contain a bio-derived frozen product, the medical container comprising:
a container body that contains the bio-derived frozen product; and
a heating unit disposed in the container body and that heats the bio-derived frozen product contained in the container body.

2. The medical container of claim 1, wherein the heating unit is arranged inside the container body.

3. The medical container of claim 2, wherein the heating unit is arranged in the bio-derived frozen product.

4. The medical container of claim 2, wherein the heating unit is a heat transfer member that transfers heat from a heat generating section disposed outside the container body into the container body.

5. The medical container of claim 2, wherein the heating unit is a heat generating body that generates heat by Joule heat.

6. The medical container of claim 1, wherein the heating unit comprises a plurality of linear heating bodies.

7. The medical container of claim 1, further comprising:
a temperature detection probe arranged inside the container body.

8. The medical container of claim 1, wherein the heating unit is arranged on an outer surface of the container body.

9. A system for melting a bio-derived frozen product, the system comprising:
a control unit; and
a medical container, the medical container comprising:
a container body that contains the bio-derived frozen product; and
a heating unit, wherein the heating unit is operatively connected to the control unit and disposed at least partially in the container body, and wherein the control unit operatively controls an output of the heating unit.

10. The system of claim 9, wherein the heating unit further comprises:
at least two heat receiving portions comprising a first heat receiving portion and a second heat receiving portion; and
a plurality of linear heat transfer bodies, wherein a first end of each of the plurality of linear heat transfer bodies contacts the first heat receiving portion, and wherein a second end of each of the plurality of linear heat transfer bodies contacts the second heat receiving portion.

11. The system of claim 10, wherein the first heat receiving portion is a first electrode, and wherein the second heat receiving portion is a second electrode.

12. The system of claim 10, wherein the plurality of linear heat transfer bodies comprises at least three linear heat transfer bodies.

13. The system of claim 10, wherein at least a portion of the first heat receiving portion and a portion of the second heat receiving portion are embedded in the container.

14. The system of claim 13, wherein the plurality of linear heat transfer bodies are disposed within the container.

15. The system of claim 9, wherein the container further comprises:
a liquid port through which the bio-derived liquid product is extracted from the medical container in a melted state; and
a temperature detection probe, and wherein the temperature detection probe is in electrical communication with the control unit.

16. A method for melting a bio-derived frozen product in a medical container comprising a first heat receiving portion and a second heat receiving portion, the method comprising:
connecting the first heat receiving portion to a heat generating section of a melting device;
connecting the second heat receiving portion to the heat generating section of the melting device; and
activating the heat generating section of the melting device heating the container, wherein the container comprises a plurality of linear heat transfer bodies, wherein the plurality of linear heat transfer bodies are disposed within the container, wherein a first end of each of the plurality of linear heat transfer bodies contacts the first heat receiving portion, and wherein a second end of each of the plurality of linear heat transfer bodies contacts the second heat receiving portion.

17. The method of claim 16, wherein the container further comprises a temperature detection probe in electrical communication with a control unit of the melting device, and wherein the method further comprises:
receiving, at the control unit, a temperature of the bio-derived frozen product measured by the temperature probe;
determining, via the control unit in response to receiving the temperature, that the bio-derived frozen product has reached a threshold temperature value; and
controlling, via the control unit, an output of the heat generating section that discontinues the heating of the container.

18. The method of claim 16, wherein the first heat receiving portion is a first electrode, and wherein the second heat receiving portion is a second electrode.

19. The method of claim 16, wherein the container comprises a liquid port.

20. The method of claim 16, wherein the plurality of linear heat transfer bodies comprises at least three linear heat transfer bodies.
